(19) United States
(12) Patent Application Publication
(10) Pub. No.: US 2008/0089333 A1
(43) Pub. Date: Apr. 17, 2008

(54) INFORMATION DELIVERY OVER TIME-VARYING NETWORK TOPOLOGIES

(76) Inventors: Ulas C. Kozat, Santa Clara, CA (US); Haralabos Papadopoulos, San Jose, CA (US); Christine Pepin, Mountain View, CA (US); Sean A. Ramprashad, Los Altos, CA (US); Carl-Erik W. Sundberg, Sunnyvale, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/873,248

(22) Filed: Oct. 16, 2007

Related U.S. Application Data
(60) Provisional application No. 60/829,839, filed on Oct. 17, 2006.

(51) Int. Cl. H04L 12/56

(52) U.S. Cl. 370/390; 370/412

(57) ABSTRACT

A method and apparatus is disclosed herein for delivering information over time-varying networks. In one embodiment, the method comprises, for each of a plurality of time intervals, determining a virtual network topology for use over each time interval; selecting for the time interval based on the virtual network topology, a fixed network code for use during the time interval; and coding information to be transmitted over the time-varying network topology using the fixed network code with necessary virtual buffering at each node.

### PRIORITY

The present patent application claims priority to and incorporates by reference the corresponding provisional patent application Ser. No. 60/829,839, entitled, “A Method and Apparatus for Efficient Information Delivery Over Time-Varying Network Topologies”, filed on Oct. 17, 2006.

### FIELD OF THE INVENTION

The present invention relates in general to managing and sending information over networks, more specifically, the present invention relates to network coding, routing, and network capacity with respect to time-varying network topologies.

### BACKGROUND OF THE INVENTION

Network coding has been proposed for attaining the maximum simultaneously deliverable throughput (minimum over all receivers) in a multicast session. FIGS. 1A and 1B show a sample network topology graph with one sender S₁, two receivers R₁ and R₂ and four routers labeled 1, 2, 3 and 4. Each vertex of the graph corresponds to a unique node in the network and each edge between a pair of vertices corresponds to the network interface/link between those nodes. Such links can also be made of multiple links traversing multiple nodes, as would happen if FIGS. 1A and 1B represent overlay networks. Note also that for purposes herein a symbol can represent a bit, a block of bits, a packet, etc., and henceforth the terms “symbol” and “packet” are used interchangeably. Suppose each edge can carry one symbol per unit time. Among all the routing strategies, i.e., among all the methods that are restricted to sending on outgoing interfaces only exact copies of incoming symbols, the strategy with the highest throughput delivers 1.5 symbols per receiver per unit time. This strategy is shown in FIG. 1A. The main limiting factor for the routing strategy is that, at a bottleneck node, i.e., a node for which the incoming interfaces have more bandwidth than the outgoing interfaces, decisions must be made as to which (proper) subset of the incoming symbols are forwarded and which are dropped. For instance, node 3 in FIGS. 1A is a bottleneck node, since it has two incoming interfaces with a total bandwidth of 2 symbols per unit time, and one outgoing interface with total bandwidth 1 symbol per unit time. When node 3 receives two symbols “a” and “b” on each interface per unit time, it must either forward “a” or “b” on the outgoing interface, or some subset such as half of each portion of information. By allowing, however, each router to send jointly encoded versions of sets of incoming symbols arriving at the incoming interfaces in each use of any outgoing interface, in general, coding strategies can be designed that outperform routing in terms of deliverable throughput.

An example of such a coding strategy, referred to herein as “network coding” is depicted in FIG. 1B. Instead of just copying an incoming symbol, node 3 performs a bit-wise modulo-2 addition (i.e., XOR two symbols) and sends “(a+b)” over the link between nodes 3 and 4. As a result of this operation, receiver R1 receives “a” and “(a+b)” on two incoming interfaces, and can thus also compute “b” by bitwise XORing “a” and “(a+b)”. Similarly, receiver R2 receives “b” and “(a+b)” and can also deduce “a”. As a result, over the network depicted on FIG. 1, network coding achieves 2 symbols per receiver per unit time, a 33.3% improvement over the routing capacity.

Next consider a network that varies over time. That is, suppose that instead of observing the same network topology with the same set of nodes, links, and link bandwidths, the network varies in time. To account for this, consider a model in which a sequence of network topologies is observed where each topology differs from the previous one either in terms of a change in the set of nodes, a change in the set of links, or a change in bandwidth of any of the existing links. FIGS. 2A and 2B depict an example of a time-varying topology with link and node failures. In this example, the network topology alternates between two states corresponding to the topology graphs G1 (FIG. 2A) and G2 (FIG. 2B). In other words, the network topology goes through a sequence of states with topology graphs as follows {G1, G2, G1, G2, G1, . . . }, where each instance lasts for many symbol durations. When G1 is observed, node 4 fails and so do all the interfaces incoming to and outgoing from node 4. When G2 is observed, the links from S1 to nodes 1 and 2 fail. During the epochs where G1 is observed, one can deliver 1 symbol per receiver per unit time by using either routing or network coding. During epochs where G2 is observed, the source is disconnected from nodes 1 and 2 and no symbol can be transmitted. Assuming all graphs are observed for the same duration, one can achieve, on average, half a symbol per receiver per unit time by instantaneously adapting to the topology changes and optimizing the capacity with respect to the current graph. Achieving this rate implies the use of two distinct network codes, each one tailored to one of the two topologies (and achieving the associated minimum cut capacity). Indirectly, it is also assumed that the individual topologies are known so that the network code for each can be computed.

To understand what throughput a network can deliver, it is useful to consider the concept of a “cut” in the network. A cut between a source and a destination refers to a division of the network nodes into two sets, whereby the source is in one set and the destination is in the other. A cut is often illustrated by a line dividing the network (in a 2-dimensional space) into two half-planes. The capacity of a cut is the sum of the capacities of all the edges crossing the cut and originating from the set containing the source and ending in nodes in the set containing the destination. The capacity of a cut also equals the sum of the transmission rates over all links crossing the cut, i.e. over all links transferring data from the set including the source to the set including the set including the destination. For any source-destination pair, there exist in general many cuts. Each such cut is distinguished by the set of intermediate nodes that are at the same side of the cut as the source. Among all these cuts, the one with the minimum capacity is referred to as the “min cut” of the graph. It has been shown that the minimum cut equals the maximum possible flow from the source to a destination through the entire graph (a fact known as the max-flow min-cut theorem).

Network coding was originally proposed as a solution to the multicast problem, which aims to maximize the minimum flow between any sender-receiver pair. By properly encoding information at the interior nodes of the network, one can achieve the multicast capacity (i.e., the minimum value of capacity over all cuts on the corresponding topology graph between the sender and any of the receivers). In general, for arbitrary networks, simple routing (i.e., forwarding of the information) cannot achieve the multicast capacity. It has also been shown that performing linear encoding (i.e., linear combinations of incoming packets) at the interior nodes is sufficient to achieve the capacity of multicast networks. It has also been shown that, for multicast networks, network coding can be used to recover from non-ergodic network failures (e.g., removal of a connection between two interior nodes) without requiring adaptation of the network code to the link failure pattern, as long as the multicast capacity can be still achieved under the given failure. This requires knowledge of the family of failure patterns under which the network graph can still sustain the same multicast capacity. Given that the failure patterns do not change the multicast capacity, a network code can be designed a priori that achieves the multicast capacity without knowing which failure will occur, but with the knowledge that any, but only one failure in the family of failure patterns can occur at a given period of time.

The drawbacks of such approaches are that the network topology has to be available, i.e., the connections between the network nodes as well as their individual rates have to be known in order to derive the encoding and decoding operations at every node at a given point in time. Therefore, encoding and decoding algorithms are built for a given topology for a given time. These algorithms usually change when the topology changes.

The aforementioned algorithms can have merit under special cases involving multicast settings with link failures. Here robust multicast can be achieved with a static network code if, as the network changes, the multicast capacity (minimum cut) remains at least as large as the throughput targeted by the designed static code. That is, there are cases where a static network code can handle a time varying network once the throughput being targeted is supportable for all possible snapshots of the network. Note, however, that the resulting throughput may not be the highest achievable throughput. The time-varying network in FIG. 2 represents one such example, where higher throughput can be obtained by coding over graphs. Indeed, the use of a static code that operates over each graph separately can at most achieve zero rate as the network of FIG. 2B has a min cut (multicast) capacity of zero. In general, these techniques allow the use of a static code for multicasting at the minimum (over time) multicast capacity, which may be considerably lower than the throughput achievable by network coding symbols over the entire set of time-varying networks. Again, in the case of FIG. 2, this capacity would be in fact zero, though one can think of other cases of FIG. 2B where links do exist between S1 and nodes 1 and 2 that have some low, though non-zero, capacity. It should be clear from this example that the approach can lead to lower throughput than the one achieved by algorithms that consider the collection of network realizations as a whole, as will be later described in the example of FIG. 3.

Another class of schemes that may be used to address robustness to changes in the network is a distributed scheme. Random network coding is one such example. Random network coding is a process in which the coefficients of the linear combinations of incoming symbols at every node are chosen randomly within a field of size 2^{m}. It has been shown that a value m=8 (i.e., a field of size 256) usually suffices, in the sense that it allows recovering the original source packets at any receiver with very high probability. This scheme is distributed in the sense that it does not require any coordination between the sender and the receivers. Receivers can decode without knowing the network topology, the encoding functions, or the links that have failed. This decentralization of network coding is achieved by including the vector of random coefficients within each encoded packet, at the expense of bandwidth (i.e., small overhead associated with the transmission of this extra information).

There are, however, drawbacks associated with random distributed network coding. Firstly, each encoded packet has some overhead (e.g., random code coefficients) that has to be communicated to the receiver. This overhead may be significant for small-sized packets (e.g., in typical voice communications). Secondly, some encoded packets may not increase the rank of the decoding matrix, i.e., they may not be classified as “innovative” in the sense of providing additional independent information at nodes receiving these packets. These non-innovative packets typically waste bandwidth. As a result, the average time it takes to decode an original source packet in general increases. Transmission of non-innovative packets can be avoided by monitoring the network, i.e., each node arranges with its neighbors to transmit innovative packets only by sharing with them the innovative packets it has received so far. However, such additional monitoring mechanisms lead to additional overhead, as they use extra network resources that could be used for other purposes. Random codes also have the processing overhead due to the use of a random number generator at each packet generation, decoding overhead due to the expensive Gaussian Elimination method they use, and decoding delay due to the fact that rank information of random matrices does not necessarily correspond to an instantaneous recovery rate. Indeed, one may have to wait until the matrix builds enough rank information to decode partial blocks. The methods that guarantee partial recovery in proportion to the rank information require extra coding which can substantially increase the overhead. The method can also generate overheads at individual nodes by requiring such nodes to keep large histories of prior received packets in buffers. In particular, the theory behind random network coding approaches (and their performance) often includes the assumption that, when a new packet comes into a node, it is combined linearly (using a random linear combination) of all prior received packets.

A PET (Priority Encoding Transmission)-inspired erasure protection scheme at the source has been also proposed that can provide different levels of protection against errors to different layers of information. An attractive attribute of this scheme is that a receiver can recover the symbols (in the given Galois field) in the most important layer by receiving only one encoded packet. Similarly, symbols in the second most important layer can be recovered if the receiver receives at least two linearly independent encoded packets, symbols in the third most important layer can be recovered if the receiver receives at least three linearly independent encoded packets, and so on. The major disadvantage of the aforementioned PET scheme is that prioritized source packets can be significantly longer than the original source packets, when a large number of different priority levels is used.

### SUMMARY OF THE INVENTION

A method and apparatus is disclosed herein for delivering information over time-varying networks. In one embodiment, the method comprises, for each of a plurality of time intervals, determining a virtual network topology for use over each time interval; selecting for the time interval based on the virtual network topology, a fixed network code for use during the time interval; and coding information to be transmitted over the time-varying network topology using the fixed network code with necessary virtual buffering at each node.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIGS. 1A and 1B illustrate throughput-maximizing routing and network coding algorithms on a sample network topology graph.

FIGS. 2A and 2B illustrate an example of time-varying topology graphs with link and node failures, along with algorithms designed for each graph, each achieving the multicast capacity over the corresponding graph, yielding an overage rate of half a symbol per receiver per unit time.

FIGS. 3A and 3B illustrate a strategy for the time-varying topology graphs of FIG. 2, whereby a single code is employed over both graphs with the use of buffers, achieving a rate of one symbol per receiver per unit time.

FIG. 4 is a flow diagram of one embodiment of a process delivery of information over a time-varying network topology.

FIG. 5 is a high-level description of one embodiment of a process for network coding over time-varying network topologies.

FIG. 6 illustrates an example of a weighted topology graph.

FIG. 7 illustrates one embodiment of a virtual buffer architecture design for a node of a network with the topologies shown in FIG. 2.

FIG. 8 illustrates an embodiment of the virtual buffer system at a node of an arbitrary network.

FIG. 9 illustrates another embodiment of the virtual buffer system at a node of an arbitrary network.

FIG. 10 is a block diagram of an exemplary computer system.

### DETAILED DESCRIPTION OF THE PRESENT INVENTION

Methods and apparatuses for performing network coding over network topologies that change with time are disclosed. One embodiment of the invention provides a systematic way of increasing, and potentially maximizing, the amount of information delivered between multiple information sources (e.g., senders) and multiple information sinks (e.g., receivers) over an arbitrary network of communication entities (e.g., relays, routers, etc.), where the network is subject to changes (e.g., in connectivity and connection speeds) over the time of information delivery. Embodiments of the present invention differ from approaches mentioned in the background that look at static networks (fixed connectivity and connection speed), providing higher throughput than such prior art in which codes are designed to be robust over a sequence of topologies. Embodiments of the present invention are different from the approach of using random network codes.

Each network node (e.g., each sender, receiver, relay, router) consists of a collection of incoming physical interfaces that carry information to this node and a collection of outgoing physical interfaces that carry information away from this node. In a scenario of interest, the network topology can change over time due to, for example, interface failures, deletion or additions, node failures, and/or bandwidth/throughput fluctuations on any physical interface or link between interfaces.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

### Overview

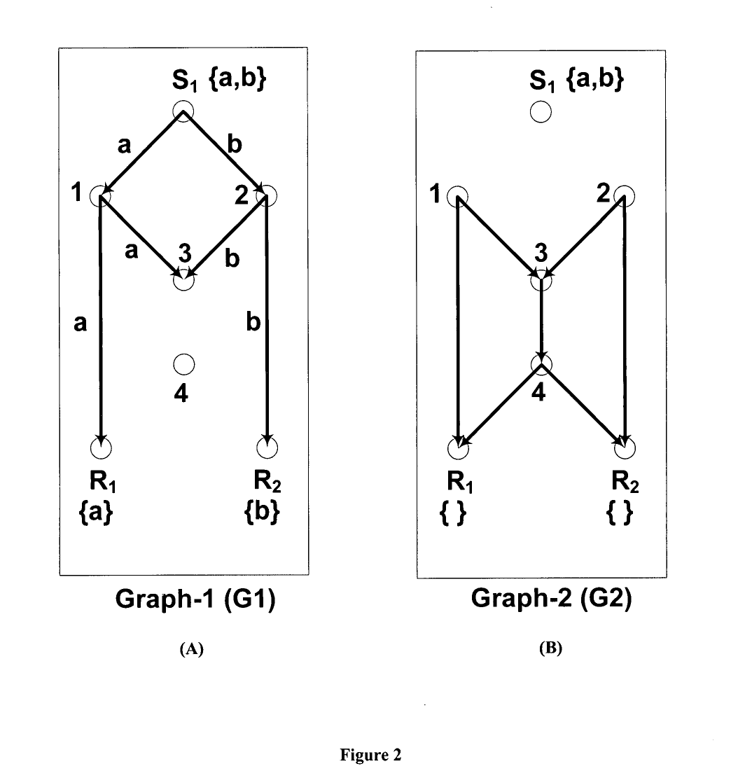

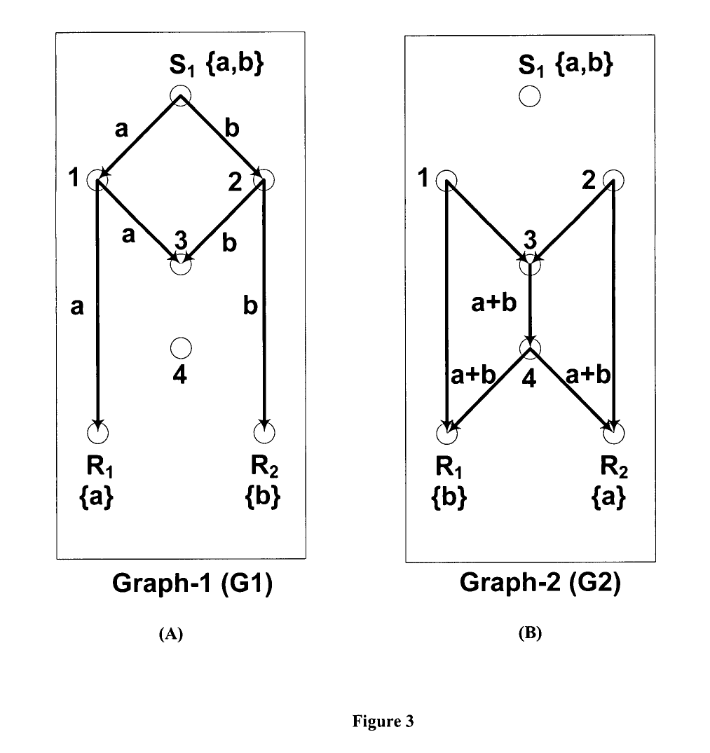

One can increase the average multicast rate by designing a strategy that targets the long-term network behavior. FIGS. 3A and 3B show such a strategy applied to the alternating network example in FIGS. 2A and 2B. The strategy in FIG. 3 achieves a rate of one symbol per receiver per unit time. The method employs a single network code that is selected based on what we term a “virtual network” topology, and is implemented over the sequence of instantaneous topologies by exploiting the use of buffers at each node. Unlike random network coding, the code is not random. In addition, unlike random network coding where buffer sizes may grow in an unbounded fashion over time leading to long decoding delays, the technology described herein can achieve the maximum throughput over a broad class of time-varying networks with finite buffer sizes and lower decoding delays.

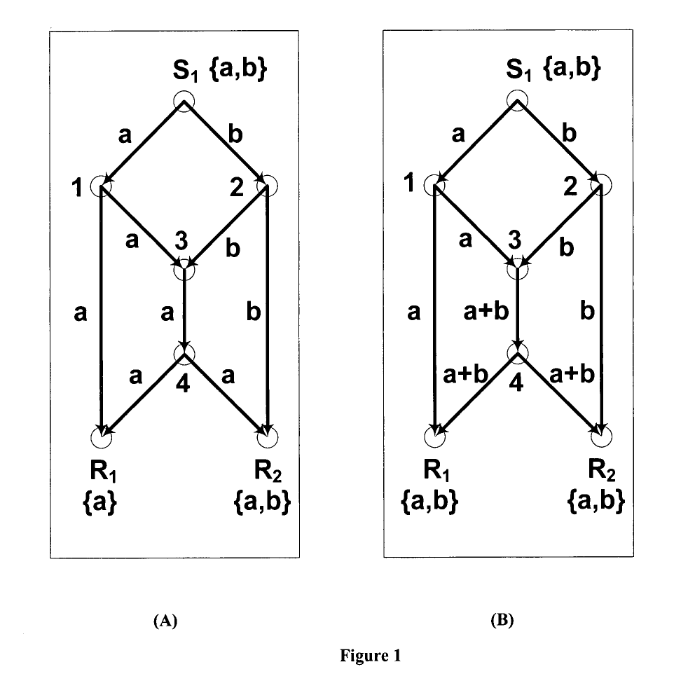

Using an embodiment of the present invention, the optimal code used in FIG. 3 is related to the code used in FIG. 1B. Specifically, if one considers in this case the “virtual topology” to be the average topology of the topologies in FIG. 2 (or 3), i.e. the average graph of the two graphs of FIGS. 2A and 2B, the code that one would apply is in fact the same as the code shown in FIG. 1B. According to this code, the source simply sends two distinct symbols over two uses of the average graph, one on each of the outgoing interfaces. Nodes 1, 2, and 4 simply relay each incoming packet over each outgoing interface, while node 3 outputs the XORed version of each pair of packets from its incoming interfaces.

However, applying such a code over the time varying network of FIG. 3 has to be performed taking into account the time variations in the graphs. Careful inspection of the local implementation of the network-coding function at node 3 (FIG. 3) reveals that, during the G1 session, node 3 generates “(a+b)”, but since it cannot send the coded packet over its outgoing interface to node 4 during this epoch, it stores it and waits for link restoration. Link restoration happens in the next G2 epoch, and once the link between nodes 3 and 4 is active, the stored information is forwarded. As a result, during G1, receiver R1 receives “a” and receiver R2 receives “b”. During G2, both receivers R1 and R2 receive “(a+b)”, which they use to decode “b” and “a,” respectively. Over each G1-G2 cycle, this strategy achieves 1 symbol per receiver per unit time, which is twice the maximum achievable rate by either routing or network coding methods that do not code across these time-varying topologies.

Embodiments of the present invention achieve the gains mentioned above over a broad class of time-varying topologies under a variety of conditions. An embodiment of the present invention uses a “virtual topology” to define a fixed network code that does not need to be changed as the topology changes, The code is implemented over the sequence of instantaneous topologies by exploiting the use of buffers at each node.

In one such embodiment if there exists an “average topology”, i.e. the long term time averages for the link bandwidths can be defined, the “virtual topology” used can be this average topology, as in FIG. 3. In this case, it can be shown in fact that this approach can obtain the highest per receiver per unit time capacity over the long run that any network coding and routing strategy can possibly achieve. This is, in fact, the case shown in FIGS. 2 and 3 using a simple alternating model in which the long-term average converges to the average of the two (equal duration) topologies. One can extend this result to cases where the durations of epochs are not equal, or where there is a series of three or more topologies.

When the long-term time averages do not exist or the session lifetimes are relatively shorter, one can use another definition of the “virtual topology”. For example, in a time varying network, one can consider a sequence of average graphs, each calculated over a limited time period, e.g. every “N” seconds over a period of “M”, “M>N” seconds. The virtual topology could be the minimum average topology considering this set of average topologies.

In another embodiment, one may consider a similar either long-term or short-term average topology in which some links, e.g. links below a minimum capacity, are removed.

In yet another embodiment, one may consider topologies as the above in which links that do not change the min-cut capacity are ignored.

In such embodiments of the present invention, the invention can also provide a sub-optimal adaptive strategy that can still perform better than or as good as instantaneous or robust strategies.

Network coding-based solutions, such as the prior embodiments based on the general principle of using a “virtual topology”, a “fixed network code”, and “virtual buffers”, that enable high-throughput low-complexity operation over networks with changing topologies are described. Solutions include, but are not limited to, (i) encoding functions that map input packets to output packets on outgoing physical interfaces at each node and techniques for buffering input packets upon arrival and output packets for transmission; (ii) mechanisms that determine the buffering time of input packets and possibly output packets and the associated number of output packets generated at each node; (iii) algorithms for updating the encoding functions at each node given deviations from the predicted transmission opportunities. One advantage of the proposed methods is that they can provide high-throughput low-complexity information delivery and management over time-varying networks, with lower decoding delays than random network coding methods. This is accomplished by addressing short-term fluctuations in network topology and performance via operation over an “induced” time-averaged (over a longer time-scale) topology.

In one embodiment, virtual buffers are needed. A virtual node architecture is described that (i) maps the incoming physical interfaces onto incoming logical interfaces; (ii) inter-connects the incoming logical interfaces to outgoing logical interfaces; and (iii) maps the outgoing logical interfaces onto outgoing physical interfaces. For example, in FIG. 3, these buffers would collect the corresponding “a” and “b” packets for a given time that need to be XOR-ed to produce a corresponding “(a+b)” packet. This packet is stored until such time that the corresponding out-going interface can deliver that packet.

The design and use of a fixed network code over a (finite- or infinite-length) sequence of time-varying networks for disseminating information from a set of sources to a set of destinations is also described. That is, during a prescribed period of time over which a network can be changing, the selection of a single network code may be made, which allows it to operate effectively and efficiently over such network variations. This is done by defining a code for a (fixed) “virtual topology”. The techniques to do so are widely known in the field and are applicable to any type of network (e.g., multicast, unicast, multiple users). In the case that (the same) information is multicast from a source to a set of destinations, the embodiment achieves high and, under certain conditions, the maximum achievable multicast rate.

In one embodiment, for instance, where the “time-averaged” sequence of networks converges as the averaging window becomes long, one embodiment implements a fixed network code that is designed for the “time-averaged” network. The implementation of the fixed network code relies on the use of virtual input and output buffers. These input (output) buffers are used as interfaces between the input (output) of the fixed network code and the actual input (output) physical interfaces. The collective effect of the use of these virtual buffers at each node facilitates the implementation of the fixed network code (designed for the virtual topology, which in this case is selected as the time-averaged topology) over the sequence of time-varying topologies that arise over the network while attaining the maximum achievable multicast throughput.

In another embodiment, a sequence of updated network codes is selected to be sequentially implemented over a sequence of time intervals. In particular, during any given update, a new network code is chosen that is to be used over the next time period (i.e., until the next update). In one embodiment, a “virtual” network topology, based on which the network code is constructed, is the predicted time-averaged topology for that period. Prediction estimates of the time-averaged topology for the upcoming period can be formed in a variety of ways. In their simplest form, these estimates may be generated by weighted time-averaging capacities/bandwidths/throughputs of each link until the end of the previous period. In general, however, they may be obtained via more sophisticated processing that better models the link capacity/bandwidth/throughput fluctuations over time and may also exploit additional information about the sizes of the virtual buffers throughout the network. If the time-averaged graphs vary slowly with time (i.e., if they do not change appreciably from one update to the next), the proposed method provides a computation and bandwidth-efficient method for near-optimal throughput multicasting.

### An Example Flow Diagram for Network Coding Over Time-Varying Network Topologies

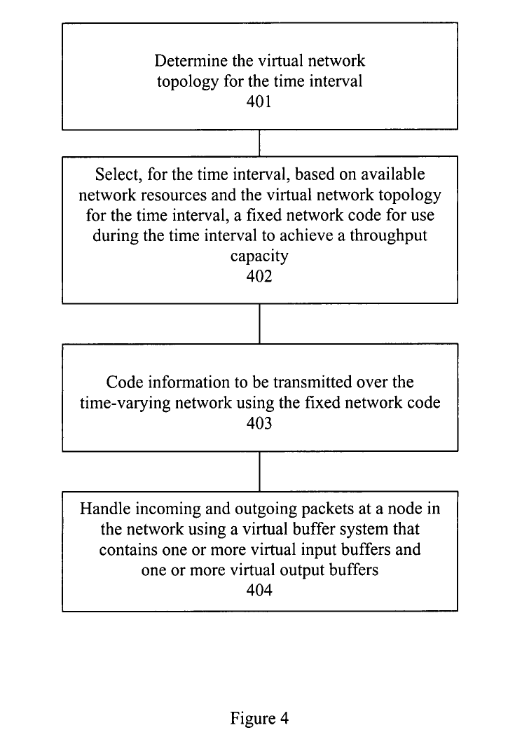

FIG. 4 is a flow diagram of one embodiment of a process delivery of information over a time-varying network topology. The process is performed by processing logic that may comprise hardware (circuitry, dedicated logic, etc.), software (such as is run on a general purpose computer system or a dedicated machine), or a combination of both.

Referring to FIG. 4, the process is performed for each of a number of time intervals. Due to the variations in the network topology over time, a (finite) set of distinct topologies arise during any such time interval. The process begins by processing logic determining a virtual topology for the given time interval (processing block 401). The virtual topology does not have to equal any of the distinct topologies that arise during the interval (and, in fact, may differ significantly from each of the actual topologies) and is to be used for constructing the network code for this time interval. In one embodiment, the virtual graph denotes an estimate of the time-averaged topology for the given time interval based on measurements collected up to the beginning of the interval. In one embodiment, these measurements include, but are not limited to, one or more available link-rate measurements, buffer occupancy measurements across the network, as well as other available information about network resources and the type of information being communicated across the network.

The time-varying network topology comprises a plurality of information sources and a plurality of information sinks as part of an arbitrary network of communication entities operating as network nodes. In such a case, in one embodiment, each network node of the topology consists of a set of one or more incoming physical interfaces to receive information into said each network node and a set of one or more outgoing physical interfaces to send information from said each network node.

In one embodiment, the virtual network topology for a given time interval is chosen as the topology that includes all the nodes and edges from the time-varying topology, with each edge capacity set to the average capacity, bandwidth, or throughput of the corresponding network interface until the current time. In another embodiment, the virtual network topology to exist at a time interval comprises a topology with each edge capacity set to an autoregressive moving average estimate (prediction) of capacity, bandwidth, or throughput of the corresponding network interface until the current time. In yet another embodiment, the virtual network topology to exist at a time interval comprises a topology with edge capacities set as the outputs of a neural network, fuzzy logic, or any learning and inference algorithm that uses the time-varying link capacities, bandwidths, or throughputs as the input.

In one embodiment, the virtual network topology is defined as the topology with the nodes and edges of the time-varying network, with each edge capacity set to a difference between the average capacity, bandwidth, or throughput of the corresponding network interface up to the time interval and a residual capacity that is calculated based on current or predicted sizes of virtual output buffers. In another embodiment, the virtual network topology comprises a topology with each edge capacity set to a difference between an autoregressive moving average of capacity, bandwidth, or throughput of the corresponding network interface up to the time interval and a residual capacity that is calculated based on current or predicted sizes of virtual output buffers. In yet another embodiment, the virtual network topology comprises a topology with edge capacities set as outputs of a neural network, fuzzy logic, or a learning and inference algorithm that uses the time-varying link capacities, bandwidths, or throughputs, as well as the current or predicted sizes of virtual output buffers as its input.

In one embodiment, the network topology varies due to one or more of link failures, link deletions, and link additions; time-varying capacity per link, time-varying bandwidth per link, time-varying throughput per link; time-varying inter-connectivity of network nodes; time-varying sharing of links with other users and applications; and node failures, node deletions, or node additions.

After determining a virtual network topology to exist at a time interval, processing logic selects, for the time interval, based on available network resources and the virtual network topology to exist at the time interval, a fixed network code for use during the time interval (processing block 402).

Once the network code has been selected, processing logic codes information to be transmitted over the time-varying network topology using the fixed network code (processing block 403). In one embodiment, the fixed network code is selected to achieve long-term multicast capacity over the virtual network. In one embodiment, selecting a network code for the time interval comprises choosing among many fixed network codes a code with optimized decoding delay characteristics. In one embodiment, selecting a network code comprises selecting, among many fixed network codes that satisfy a delay decoding constraint, the code that achieves the largest multicast capacity. In one embodiment, selecting a network code for the time interval comprises identifying an encoding function for use at a node in the topology for a given multicast session by computing a virtual graph and identifying the network code from a group of possible network codes that maximizes the multicast capacity of the virtual graph when compared to the other possible network codes. In one embodiment, computing the virtual graph is performed based on a prediction of an average graph to be observed for the session duration.

In one embodiment, coding information to be transmitted includes processing logic performing an encoding function that maps input packets to output packets onto outgoing physical interfaces at each node and determining buffering time of input packets and an associated number of output packets generated at each node.

Along with the coding process using the network code, processing logic handles incoming and outgoing packets at a node in the network using a virtual buffer system that contains one or more virtual input buffers and one or more virtual output buffers (processing block 404). In one embodiment, the network code dictates input and output encoding functions and buffering decisions made by the virtual buffer system for the node. The virtual buffer system handles incoming packets at a node and well as determines scheduling for transmitting packets and determining whether to discard packets.

In one embodiment, a node using the virtual buffer system performs the following: it obtains information (e.g., packets, blocks of data, etc.) from one or more of the physical incoming interfaces; it places the information onto virtual input buffers; it passes information from the virtual input buffers to one or more local network coding processing function blocks to perform coding based on the network code for the time interval; it stores the information in the virtual output buffers once they become available at the outputs of (one or more of) the function blocks; it sends the information from the virtual output buffers into physical output interfaces. In one embodiment, the (one or more) local network coding processing function blocks are based on a virtual-graph network code.

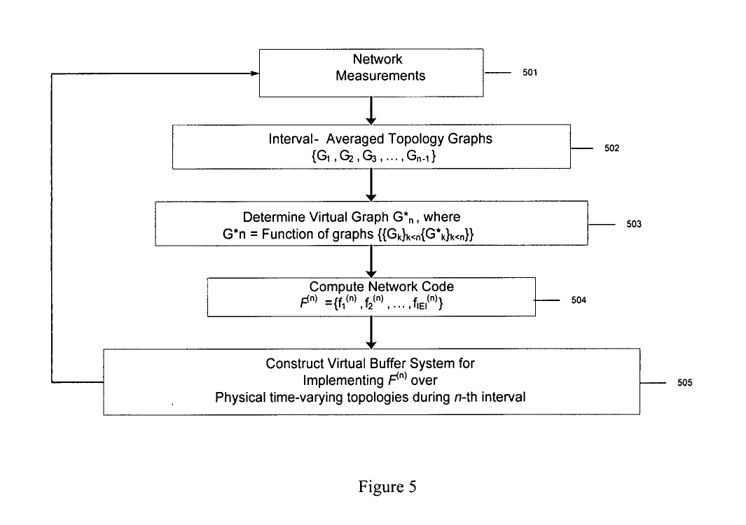

FIG. 5 is a high-level description of one embodiment of a process for network coding over time-varying network topologies. The process is performed by processing logic that may comprise hardware (circuitry, dedicated logic, etc.), software (such as is run on a general purpose computer system or a dedicated machine), or a combination of both.

Referring to FIG. 5, it is assumed that time is partitioned into intervals (referred to herein as “sessions”) of potentially different durations T₁, T₂, T₃, etc. The process begins by processing logic taking network measurements (e.g., link-state measurements, which are well-known in the art (processing block 501). After network measurements are taken, processing logic generates and/or provides interval-averaged topology graphs {G₁, G₂, G₃, . . . , Gₙ₋₁} for the n-th time interval , where “Gᵢ” refers to a topology graph for the “i-th” interval (processing block 502). Using the interval-averaged topology graphs, processing logic determines a virtual graph G*ₙ=G*({Gₖ}_{k<n},{G*ₖ}_{k<n}), where G*ₙ is a function of graphs {{Gₖ}_{k<n},{G*ₖ}_{k<n}} (processing block 503). The virtual graph represents a virtual topology. In one embodiment, the virtual graph depends on other parameters, such as, but not limited to, virtual buffer occupancies, other functions of the instantaneous graphs during past intervals, and additional constraints that emanate from the nature of information being multicasted (e.g., decoding delays in multicasting media).

Based on the virtual graph (and thus the virtual topology), processing logic computes a network code (processing block 504) and constructs a virtual buffer system for implementing the network code F⁽ⁿ⁾ over the physical time-varying topologies during the n-th interval (processing block 505). The network code F is set according to a number “|E|” of functions as in the following:

F⁽ⁿ⁾={f₁⁽ⁿ⁾, f₂⁽ⁿ⁾, . . . , f_{|E|}⁽ⁿ⁾}.

Each function can be computed at one node centrally (e.g., at the source node) and distributed to the routers (nodes). A given node needs only to know some of these functions, e.g. the ones it implements between its incoming and outgoing interfaces. Alternatively, each node in the network can compute its local functions itself, after sufficient topology information is disseminated to that node. In one embodiment, the network code is selected to be a throughput maximizing code, while in other embodiments, the network code is selected to achieve high throughput and other requirements (e.g., decoding delay requirements).

Thus, over the n-th time interval (session), the process comprises the following: (i) the formation of a virtual topology for the duration of the session, obtained via link-capacity measurements collected over the network during all cycles of (or, a subset of the most recent) past sessions; (ii) the construction of a network code for use with the virtual topology; (iii) the implementation of the network code (designed for the virtual topology) over the sequence of time-varying topologies during the n-th time interval (session) by exploiting the use of virtual buffers.

As set forth above, prior to the n-th multicasting session, a virtual topology is formed for the n-th session. In constructing the virtual topology, it is assumed that a topology control mechanism is present, providing the sets of nodes and links that are to be used by the multicast communication session. The topology control mechanism can be a routine in the routing layer. Alternatively, since network coding does not need to discover or maintain path or route information, the topology control mechanism can be a completely new module replacing the traditional routing algorithm. Topology control can be done by establishing signaling paths between the source and destination and the routers along the path can allocate resources. In an alternative setting where the topology corresponds to an overlay network, the overlay nodes allocate the path resources and routers at the network layer perform normal forwarding operations. In one embodiment, in generating the virtual topology, it is assumed that the set of instantaneous topologies during all the past sessions have been obtained via link-state measurements and are hence available. At the outset of the n-th session, the collection of weighted topology graphs {Gₖ}_{k<n},{G*ₖ}_{k<n} are available. Note this set can also be written as a function of {Gₖ}_{k<n} since {G*ₖ}_{k<n} is itself a function of {Gₖ}_{k<n}.

One can specify {Gₖ}_{k<n} by a notation {V,E,C(k) for k<n} where:
a) V denotes the vertex set representing the communication nodes;
b) E={e₁, e₂, e₃, . . . , e_{|E|}} is a set of directed edges, where the i-th edge (eᵢ) is a link or set of interfaces interconnecting a pair of vertices (α,β), where node α is the tail of the edge (α=tail(eᵢ)) and node β is the head of the edge (β=head(eᵢ));
c) C(k) denotes the assumed link-capacity on all links, or throughput vector, associated with the edge set, defining Gₖ.
   Note that these graphs are generated after the topology information is extracted. The nodes refer to the overlay nodes or routers that serve the multicast session and participate in network coding operations. The edges are the links between the routers or paths between the overlay nodes and their weights are the probed capacity/bandwidth values. Note that in one embodiment the sets V and E can vary with n.

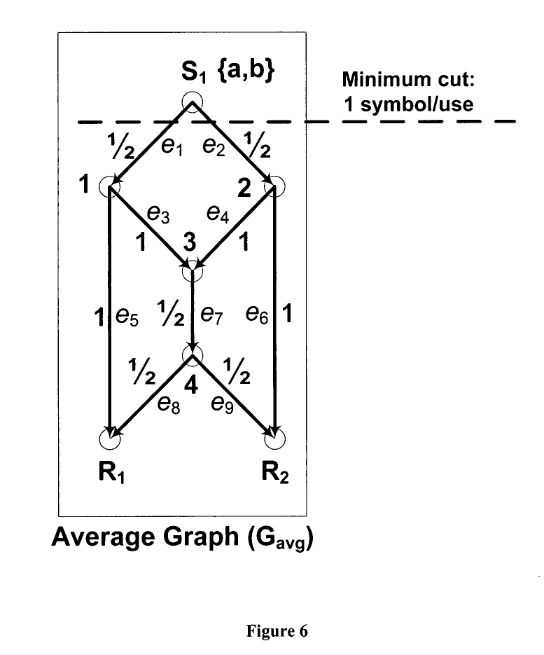

FIG. 6 presents an example of a weighted topology graph (a virtual graph) at session k, where G1 and G2, shown in FIGS. 2A and 2B, respectively, are observed in an alternating fashion and with equal duration. Referring to FIG. 6, edge capacities have long-term averages and are shown by the values next to each link. Also, next to each edge in the graph is its label. In this example, V={S₁, R₁, R₂, 1, 2, 3, 4} and E={e₁, e₂, e₃, e₄, e₅, e₆, e₇, e₈, e₉}. For instance, S₁=tail(e₁) and 1=head(e₁). Likewise, R₂=head(e₆)=head(e₉) and 4=tail(e₈)=tail(e₉). The throughput vector associated with E at the k-th session is C(k)={½, ½, 1, 1, 1, 1, ½, ½, ½}.

The multicast capacity of the virtual (average) graph is 1 symbol per cycle (determined by the minimum cut). The network code shown in FIG. 1 achieves the multicast capacity on this average graph by only partially utilizing the edge capacities of edges e₃, e₄, e₅, and e₆.

In general, Cᵢ(k) representing the i-th element of C(k) (and denoting the capacity, or throughput value estimate during the k-th session over edge eᵢ, i.e., the i-th edge of the topology graph) changes over time, although it remains bounded. The link-state measurement function tracks C(n) over time; at the outset of the n-th session, it uses knowledge of C(k) for k<n, to form a predicted (virtual) topology for the n-th session. Specifically, the virtual topology graph can be expressed as G*ₙ=G(V,E,C*(n)), where the i-th entry of C*(n) is the predicted capacity of the i-th link during the n-th session.

In general, not all the vectors {C(k), k<n} need to be used in calculating C*(n), and therefore to be used in calculating, G*ₙ.

In one embodiment, the throughput vector of the virtual topology graph is an estimate of the time-averaged link-capacities to be observed in the n-th session. In one embodiment, the computation of the estimate C*(n) takes into account other factors in addition to all C(k), for k<n. In one embodiment, the computation takes into account any available statistical characterization of the throughput vector process, the accuracy of past-session C* estimates, and, potentially, the size of the virtual buffers that are discussed herein. In another embodiment, the computation takes into account finer information about the variability of the link capacities during any of the past sessions, and, potentially other inputs, such as decoding other constraints set by the information being multicasted (e.g. delay constraints).

Letting C(k,j) denote the j-th vector of link capacity estimates that was obtained during the k-th session, and assuming τₖ such vectors are collected during the k-th session, a capacity vector for the virtual topology, C*(n), can be calculated in general by directly exploiting the sets {C(k,1), C(k,2), . . . , C(k, τₖ)}, for all k<n.

The i-th entry of C(k,j), denoting the link-capacity of the i-th link in the j-th vector estimate of the k-th session, may be empty, signifying that “no estimate of that entry/link is available within this vector estimate.”

In one embodiment, the virtual topology is computed in a centralized manner by collecting the link-state measurement data at a central location where the virtual topology is to be calculated. In another embodiment, a distributed link-state measurement and signaling mechanism are used. In such a case, assuming each node runs the same prediction algorithm, one can guarantee that each node can share the same view on the topology and the predicted averages over the new session, provided sufficient time is allowed for changes to be propagated and take effect. Finally, the available link-state measurements can also be exploited by the topology control module, in order to expand or prune the vertex set V and/or the edge set E depending on the attainable network capacity.

Once a virtual topology graph G*ₙ=G(V,E,C*(n)) is chosen for use during the n-th session, a network code is constructed for this graph. There are many existing techniques that can design deterministic, or random (pseudo-random in practice) linear network codes that achieve the maximum-flow (minimum-cut) capacity over a given fixed graph. In one embodiment, one such linear network code is chosen based on one of the existing methods for designing throughput-maximizing network codes for such fixed network graphs. Such a network code can be expressed via |E| vector-input vector-output functions {f₁, f₂, . . . , f_{|E|}} (one function per edge in the graph). Specifically, the network code function fᵢ, associated with edge eᵢ, outputs a vector of encoded packets yᵢ of dimension Cᵢ*(n), where Cᵢ*(n) is the i-th element of C*(n). Let k=tail(eᵢ) denote the tail of edge eᵢ, and let Vₖ denote the subset of indices from {1,2, . . . , |E|} such that the associated edges in E have node k as their head node. Let also Yₖ denote the vector formed by concatenating all vectors yⱼ for all j in Vₖ (denoting all the vectors of encoded packets arriving to node k through all its incoming edges), and let cₖ*(n) denote its dimension (which is equal to the sum of the Cⱼ*(n) over all j in Vₖ). Then, the vector of encoded packets that is to be transmitted over edge eᵢ out of node k is formed as follows

yᵢ=fᵢ(Yₖ)=WᵢYₖ, (1)

where the scalar summation and multiplication operations in the above matrix multiplication are performed over a finite field, and Wᵢ is a matrix of dimension Cᵢ*(n)×cₖ*(n) with elements from the same field. Although not stated explicitly in the functional descriptions of Wᵢ, yᵢ, and Yₖ, in general, their dimensions depend not only on the edge index i, but also on the session index n.

The edge capacities of a virtual graph may not be integers. In that case, each edge capacity Cᵢ*(n) is scaled by a common factor t(n) and rounded down to the nearest integer, denoted by Qᵢ*(n). The network code outputs on edge eᵢ a vector yᵢ of dimension Qᵢ*(n). Similarly, the dimensions of Wᵢ are Qᵢ*(n)×cₖ*(n), where cₖ*(n) is the dimension of Yₖ (denoting the vector formed by concatenating all vectors yⱼ for all j in Vₖ).

In one embodiment, each packet consists of several symbols, where each symbol consists of a finite set of bits. The number of bits in a symbol is defined as the base-2 logarithm of the order of the finite field over which the linear combinations are formed. The linear combinations are applied on a symbol-by-symbol basis within each packet.

In an alternative embodiment, where the minimum cut capacity can be achieved using a network code that does not utilize all the available capacity of each edge, then an overall capacity-achieving network code can often be selected which may generate sets of yᵢ's, whereby some of the yᵢ's have dimension less than Cᵢ*(n).

Finally, associated with each receiver is a linear vector-input vector-valued linear function that takes all the available packets at the incoming virtual interfaces and recovers the original packets. Each of these decoding operations corresponds to solving a set of linear equations based on the packets received from all the incoming edges at the receiving node. Note that intermediate nodes, i.e., nodes that are not final receivers of information, can also perform such decoding operations in calculating messages for their outgoing interfaces.

As is well known in the prior art, by properly selecting the size of the finite field and the set of coefficients used in the linear network-coding transformations over a fixed graph, one can attain the maximum achievable multicast capacity over a fixed graph. In one such example, one can select the coefficients randomly at the start of each time-interval and use them until the next interval where the virtual graph will change and, with high probability, the resulting network code will be throughput maximizing over the fixed graph.

### Calculation of the Network Coding Function

In one embodiment, the calculation of a network coding function is based on a virtual topology graph G*ₙ This network coding function works effectively over the actual time-varying networks. The use of the network code that was designed for the virtual graph relies on emulation of the virtual graph over the instantaneous physical graphs that arise in the network over time. Such emulation accommodates the fact that the sequence of physical topologies observed can, in general, be significantly different from the virtual topology that was assumed in designing the network coding functions f₁, f₂, . . . , f_{|E|}. In one embodiment, emulation of the virtual graph over the instantaneous physical graphs is accomplished by exploiting a virtual buffering system with respect to the fᵢ's. In one embodiment, the virtual buffer system consists of virtual input and virtual output buffers with hold/release mechanisms, designed with respect to the virtual-graph network code. Note that, as shown herein, the operation of these buffers is more elaborate than simply locally smoothing out local variations in link capacities, especially when alternating between various extreme topologies. In particular, it allows optimizing the choice of the network code used on the virtual graph in an effort to achieve objectives such as high throughput, low decoding complexity, and low decoding delay.

### Virtual Buffer and Node Architectures

The choice of the virtual-graph network code determines the set of network-coding functions implemented at each of the nodes, and, consequently, the associated virtual buffer architecture at each node. The principles behind designing a virtual buffer architecture can be readily illustrated by considering the sequence on networks presented in FIG. 2, where the network topology alternates between G1 and G2. The average topology can be accurately modeled and predicted in this case and is shown in FIG. 6. The multicast capacity in this case equals 1 symbol per unit time (computed by finding the minimum cut between the source and receivers over the average graph), and corresponds to the maximum rate (or flow) that is achievable for any sender-receiver pair in the long run over the sequence of the observed time-varying topologies. Note that the capacity-achieving network code of the graph in FIG. 1 also achieves the multicast capacity of the average (virtual) graph.

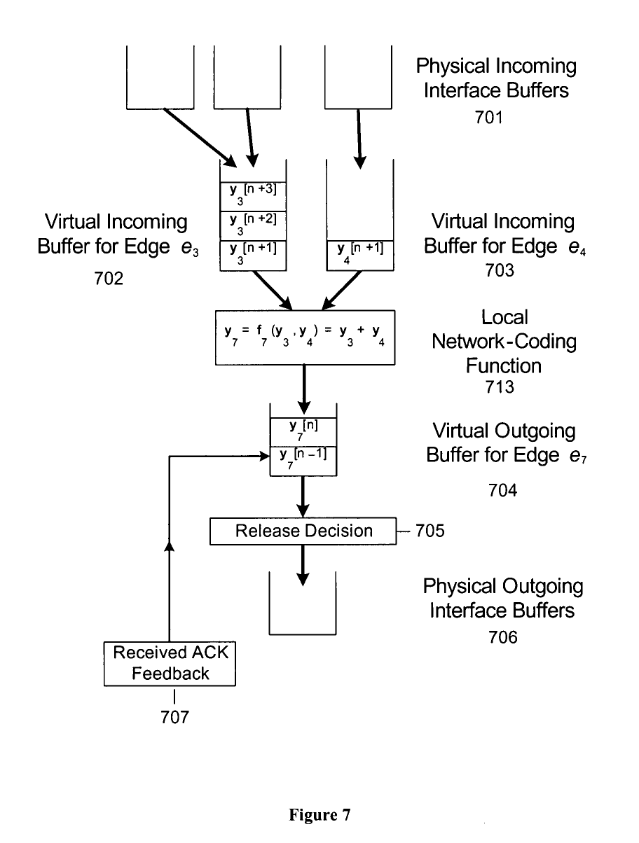

FIG. 7 illustrates an example of a virtual buffer architecture design for node 3 of the network with the topologies shown in FIG. 2. The network code for the average (virtual) graph (alternating topology graphs G1 and G2) dictates that node 3 XORs two distinct pairs of encoded packets incoming from two different edges and transmits the outcome on the outgoing edge. Physical incoming interface buffers 701 supply packets to virtual incoming buffers for edge e₃ 702 and edge e₄ 703.

When both of the virtual incoming buffers 702 and 703 have packets waiting, the local network-coding function 713 takes one packet from the head of each of virtual incoming buffers 702 and 703, XORs them and puts the encoded packet at the tail of the virtual outgoing buffer for edge e₇ 704. Then the two packets that were XORed are removed from the associated virtual input buffers 702 and 703. The procedure is repeated until at least one of the virtual input buffers 702 and 703 is empty. When the physical outgoing buffer 706 is ready to accept packets (e.g., the physical link is up and running), a release decision 705 (a decision to release the packet to the physical outgoing interface buffer 706) is made and the packet waiting at the head of the virtual outgoing buffer 704 is copied into the physical outgoing interface buffer 706. Once an acknowledgement of successful transmission of the packet is received (e.g., received ACK feedback 707), the packet is removed from the virtual output buffer 704.

Virtual buffers allow node 3 to continue network coding in a systematic manner, as packet pairs become available and to store the resulting encoded packets until the physical outgoing interface is ready to transmit them (e.g., physical outgoing interface buffers 706 are ready to transmit).

Note that the use of a deterministic network code (achieving the multicast capacity on the average graph) allows one to decide in a systematic low-complexity manner the information that needs to be stored and/or network coded so that the multicast capacity is achieved. Furthermore, it is guaranteed that this maximum capacity is achieved with an efficient use of storage elements (incoming packets are discarded once they are no longer needed by the fixed network code), as well as efficient use of transmission opportunities (it is a priori guaranteed that all packets transmitted by any given node are innovative). For instance, the network code of FIG. 7 achieves the multicast rate of the virtual graph in FIG. 6 by using only half of the available capacity of each of the edges e₃, e₄, e₅, and e₆.

Other embodiments of the virtual buffer architecture for implementing the network code at node 3 use a single virtual input buffer, with a more complex hold-and-release mechanism. In one such embodiment, both the y₃ and y₄ data (data from different physical incoming interface buffers 701) are stored in non-overlapping regions of the virtual input buffer as they become available to node 3. The hold-and-release mechanisms keep track of which of the available y₃ and y₄ data have not been network coded yet.

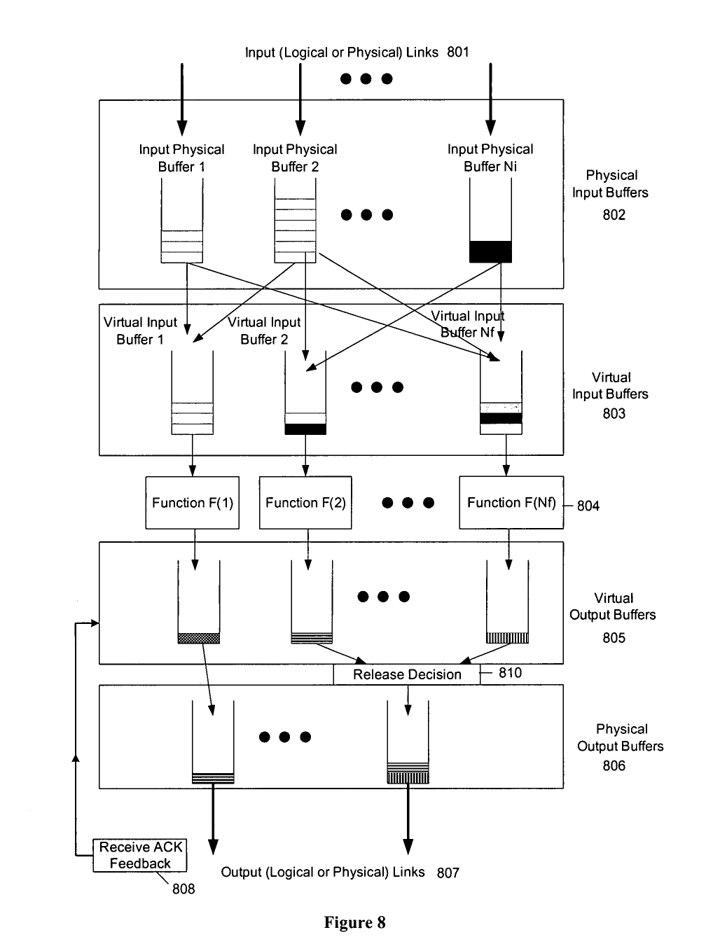

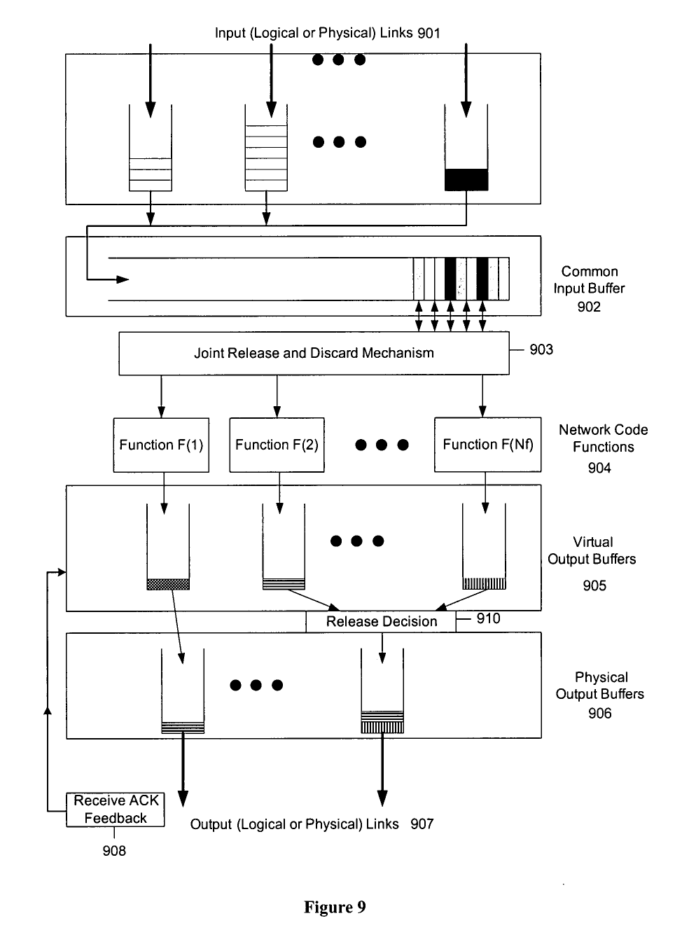

Two embodiments of the virtual buffer system at a typical node of an arbitrary network are depicted in FIG. 8 and FIG. 9. Shown in these embodiments are “Ni” input links and “No” output links to the network node.

FIG. 8 illustrates an embodiment of a node using virtual input buffers and virtual output buffers at node k, including (optional for some embodiments) a release decision mechanism. Referring to FIG. 8, “F(i)” denotes a scalar network-coding function locally implemented at node k. Letting Xₖ denote the set of all indices of the edges with node k as their tail, F(i) implements (at least) one element of the vector function fⱼ⁽ⁿ⁾ (see FIG. 5) for some j in Xₖ.

Specifically, input links 801 (e.g., logical links, physical links) feed packets to physical input buffers (1-Ni) 802, which in turn feed the packets to various virtual input buffers (1-Nf) 803. Packets in each of the virtual input buffers 803 is sent to one of the network coding functions F(1)-F(Nf) 804. The outputs of the network coding functions 804 are sent to distinct virtual output buffers 805. The coded data from virtual output buffers 805 are sent to physical output buffers 806, which in turn send them to output links 807 (e.g., logical links, physical links). Coded data from one of the virtual output buffers 805 is sent directly to one of the physical output buffers 806, while the other coded data from two of the virtual output buffers 805 are sent to the same one of physical output buffers 806 based on a release decision 810. Acknowledgement (ACK) feedback 808, when received, causes data to be removed from the virtual output buffers.

FIG. 9 illustrates an embodiment of a node k where a common input buffer is used in conjunction with a “Release and Discard” mechanism. Referring to FIG. 9, “F(i)” denotes a scalar network-coding function locally implemented at node k. Letting Xₖ denote the set of all indices of the edges with node k as their tail, F(i) implements (at least) one element of the vector function fⱼ⁽ⁿ⁾ (see FIG. 5) for some j in Xₖ.

Specifically, input links 901 (e.g., logical links, physical links) feed packets to the common input buffer 902, which in turn feed the packets to the joint release and discard mechanism 903. Packets in each of the virtual input buffers 803 are sent to one of the network coding functions F(1)-F(Nf) 904. The results of the coding by network coding functions 904 are sent to distinct virtual output buffers 905. The coded data from the virtual output buffers 905 are sent to the physical output buffers 906, which send them to the output links 907 (e.g., logical links, physical links). Coded data from one of the virtual output buffers 905 is sent directly to one of the physical output buffers 906, while other coded data from two of the virtual output buffers 905 is sent to the same one of the physical output buffers 906 based on a release decision 910. Acknowledgement (ACK) feedback 908, when received, causes data to be removed from the virtual output buffers.

Thus, as shown in FIGS. 8 and 9, packets from the “Ni” input links can be buffered into as many as “Ni” physical input buffers (shown in FIG. 8), and (usually) into as few as a single common input buffer (illustrated in FIG. 9). Similarly, although there could be as many as “No” physical output buffers, in reality there may be only a single common output buffer serving all output links. For the purpose of these embodiments, the number of the actual physical input/output buffers is of secondary importance, since the notion of a “link” may not necessarily match that of physical interfaces. For instance, several links may employ the same physical input interface, or they may simply correspond to different logical connections and/or different routing tunnels to other network elements.

FIGS. 8 and 9 also show the network-coding processor at the given sample node, which, as defined by the network code for the virtual graph, implements “Nf” scalar functions “F(1)”, “F(2)”, . . . , “F(Nf).” In one embodiment, each of these functions is an operation defined on vectors of input packets whose size is dictated by the network code selected for the virtual graph. One of the attractive features of network-code design described herein that is based on a virtual graph is that, depending on the network code selected, different processing functions at a given node may use distinct subsets of packets (i.e., not necessarily all the packets) from each of the input packet vectors. In the embodiment in FIG. 8, there are “Nf” virtual input queues, one for each function. In particular, the queue associated with “F(k)” in this case collects only the subset of input packets required for performing operation “F(k)”. With the embodiment of FIG. 8, with one virtual input buffer feeding each function, a virtual input buffer simply releases packets to the function when it has collected a group of packets necessary for a unique execution of the function. Packets released to the function that are no longer required for future function executions are discarded (i.e., removed from the virtual input buffer). In this sense, the virtual input buffers are focused on the operation of simply collecting packets required by the functions with a simple “release when ready” mechanism. As illustrated in FIG. 9, one can also consider other embodiments where more or fewer than “Nf” queues are used. For instance, any given network coding function can potentially obtain packets from more than one input virtual buffer (queue), while in other cases two or more of these functions can share common virtual input buffers (queues). Also, a function “F(k)” may be used more than once.

Virtual output buffers collect and disseminate network coded packets. In particular, during a single execution of a given function “F(k)”, one network-coded output packet is generated for transmission and appended to the associated virtual queue. The hold and release mechanisms of these output buffers are responsible for outputting the network coded data in the physical output queues. Given that the rate of flow out of physical buffers is determined by the state of the links and possibly additional operations of the network node, and can thus be dynamic, these hold-and-release mechanisms can be designed to have many objectives. In one embodiment, the virtual buffers copy subsets of (or, all) their packets without discarding them, to the physical output buffer. A packet is discarded from the virtual outgoing buffer if its transmission is acknowledged by the physical link interface. In case of transmission failure, however, the packet is recopied from the virtual outgoing buffer (without being discarded) to the physical output buffer. In another embodiment, the hold-and-release mechanism of the virtual output buffers plays the role of a rate-controller, limiting the release of the packets at the rate supported by the physical layer. Release decisions in this embodiment can be based on the buffer occupancy of the physical layer and the instantaneous rates of the outgoing links.

In more advanced embodiments, also illustrated in FIG. 8 and FIG. 9, the release mechanism may be more elaborate. The release mechanism could be a joint operation across more than one virtual output buffer/function. For example, when a common physical output buffer (or link) is used for more than one function, the release mechanism may prioritize the release of coded packets depending on one or more of a number of factors (depending on the embodiment) including, but not limited to: (i) relative priority of coded packets; (ii) relative timestamp (age) of the packet in the network; (iii) the relative influence each packet has in enabling timely network encoding and/or decoding at subsequent destinations, etc.

Another set of embodiments that can be viewed as an alternative to those illustrated in FIGS. 8 and 9 arises from the representation of the network code in the form of Equation (1). These embodiments include many virtual input buffers for each scalar network-coding function. Specifically, associated with the virtual output buffer carrying the scalar data for one of the entries of yᵢ in Equation (1) (i.e., associated with the scalar network coding function that generates this element of yᵢ), there can be as many as cₖ*(n) virtual input buffers, each storing and releasing the data of the entries of Yₖ that are employed in the scalar network-coding function (with non-zero scaling coefficients).

There are fundamental differences between the virtual buffers used in embodiments described herein and the physical input and physical output buffers (for storing received packets or packets awaiting transmission) that have already been provisioned in many existing network elements (e.g. 802.11 access points, IP routers, etc). Such physical input/output buffers can take various forms. In some systems, a common physical Input/Output (I/O) buffer is employed (e.g., a First-In First-Out queue serving both functions in hardware), while in other cases multiple buffers are used, each serving a particular class of Quality of Service. Typically, when a packet is scheduled for transmission, it is removed from the interface queue and handed to the physical layer. If the packet cannot be delivered due to link outage conditions, after a finite number of retransmissions, the packet is discarded. On the other hand, virtual buffers are designed so as to enable the implementation of the (fixed) network coding functions (dictated by the virtual-graph network code) over the set of network topologies that arise over time. They accomplish this goal by accumulating and rearranging the packets that are required for each local network-code function execution, used in conjunction with hold-and-release operations that are distinctly different from those used in physical queues. The virtual buffer sizes (maximum delays) are set in accordance with the network code that is being implemented, i.e., they are set so as to maintain the average flow capacity out of the node required (or assumed) by each function in the network code design. Specifically, assuming the virtual-graph network code is designed in a way that requires on average flow of “R_{k,i}” units/sec on link “i” out of node “k”, the virtual buffer size and hold/release mechanism of packets to that link are designed to maintain that required flow rate R_{k,i} over link i out of node k, regardless of the instantaneous capacity of the link, which at any time can be greater, equal, or smaller than R_{k,i}. This flow rate is required by network coding functions by subsequent nodes in the information path. In fact, the link may be used for transmitting packets from other functions, each having their own average flow requirements. Virtual buffers allow sharing of links over many functions in this case. The systematic methods described herein for the virtual-graph network code design and implementation ensure that the required data flow can be handled by each link on average, i.e., that R_{k,i} is less than or equal to the average throughput that link “i” can handle.

In another embodiment, each node locally selects the coefficients of its (linear) network-coding functions. The embodiment can be viewed as a decentralized alternative to the aforementioned approach where a virtual graph is first centrally calculated and used to estimate the multicast capacity and construct the network code. In the embodiment, portions of the virtual graph are locally obtained at each node. Specifically, the estimate of the capacity of any given edge is made available only to the tail node and the head node associated with this edge, and the resulting locally available information at each node is used for generating local network-coding functions (including the local code coefficients). “Throughput probing” can then be performed over the network for tracking the multicast throughput achievable with the given network coding functions (and thus the maximum allowable rate at the source).

Throughput-probing is a method that can be used to estimate the multicast capacity of a (fixed) graph without knowledge of the entire graph. It also allows the source to adjust its rate during each session so as to track long-term throughput fluctuations over sequences of sessions. When the actual throughput during a session is lower than the one predicted by the average graph, the network coding operations performed during the session provide adequate information for throughput probing. For instance, throughput probing can be accomplished by estimating the rates of data decoding at all destination nodes, and making those rates available to the source. The attainable multicast throughput can be estimated at the source as the minimum of these rates and can then be used to adjust (reduce in this case) the source rate for the next cycle. However, when the actual achievable throughput during a session is higher than the source rate used by the virtual-graph network code (i.e., higher than the minimum cut of the associated virtual graph), more information is needed for throughput probing beyond what is available by the network coding operations. In one embodiment, this additional information may be provided by the following two-phase algorithm.

In the first phase of the algorithm, the local network coding functions at the source node are designed for a source rate Rₘₐₓ at every session, where Rₘₐₓ denotes the maximum operational source rate in packets per second. Specifically, in each session, the network code at the source node operates on a vector of Kₘₐₓ(n) source packets every t(n) seconds, where Kₘₐₓ (n) equals Rₘₐₓ×t(n). Both Rₘₐₓ and t(n) are design parameters of the embodiment. Let R(n) denote the estimate of the source rate that can be delivered during the n-th session, and assume that R(n) does not exceed Rₘₐₓ. To guarantee that the source rate delivered during the n-th session is limited to R(n) (even though the network code was designed to operate at a rate Rₘₐₓ), only K(n)=R(n)×t(n) out of Kₘₐₓ(n) packets in each input vector is used to carry information, while the rest of the vector is set to zero.

In the second phase, each intermediate node first sends data according to the fixed network code and opportunistically sends more coded packets, whenever extra transmission opportunities become available (and assuming there is no more data in the virtual output buffer). This incremental expansion of the local-network codes exploits additional transmission opportunities that are not exploited by the fixed code for the virtual graph, thereby allowing sensing of potential increases in throughput at the destinations.

The first phase together with the second phase allows one to estimate the multicast throughput by calculating the minimum decoding rate, i.e., calculating the number of independent linear equations to be solved at each receiver node and selecting the smallest one as the new source vector dimension for the next session (the new source rate is obtained by dividing the new source vector dimension by t(n)). For example, if the minimum source vector dimension is d(n) and d(n)>K(n), then at least d(n)−K(n) additional packets can be transmitted in each input vector (for a total of d(n) packets in each source vector). In one embodiment, throughput probing is performed more than once during a session, in which case the adjusted source rate is the average of the minimum decoding rates.

The throughput probing algorithm may also be used in the case where the actual throughput during a session is lower than the one predicted by the average graph. In that case, the minimum decoding rate d(n)/t(n) is smaller than K(n)/t(n) and is used as the new source rate. The additional overhead for such throughput probing consists of two terms: (i) the number of bits that are required to describe the additional coefficients of the extra source packets used in each linear combination; and (ii) a few extra bits in order to be able to uniquely identify at each destination the number of non-zero-padded source packets used within each source input vector block. This additional overhead may be transmitted to the receivers once at the beginning of each session.

In summary, implementation-efficient and resource-efficient methods and apparatuses for realizing the benefits of network coding (in terms of achieving maximum flow capacity between a set of senders and a set of receivers) over time-varying network topologies have been described. These methods and apparatuses systematically select and implement a fixed network code over a session, during which the network topology is time-varying. Specifically, in one embodiment:
1. A time varying topology is mapped to a virtual (graph) topology G*(V,E,C*(n)) for a given time session.
2. The virtual topology is used with existing methods which apply to fixed topologies to define a good network code, and
3. The network code is effectively implemented over the time-varying graph with the help of virtual buffers defined by the network code.

Under a wide range of conditions, the techniques described herein allow attaining optimal or near-optimal multicast throughput in the long-term. Since the network code employed by the proposed method stays fixed over each session and many different codes exist that achieve the same performance, the method allows one to select a near throughput-maximizing code with low decoding delay and complexity. Compared to other random network coding approaches proposed in the literature, for instance, the proposed codes can provide either lower decoding complexity and lower decoding delay for the same throughput, or higher throughput at comparable decoding complexity and decoding delay.

### An Exemplary Computer System

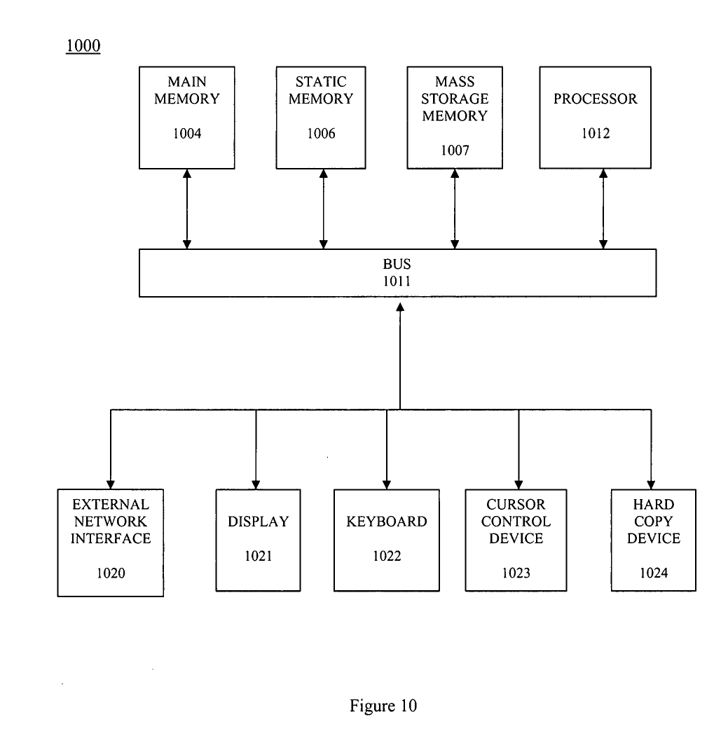

FIG. 10 is a block diagram of an exemplary computer system that may perform one or more of the operations described herein. Referring to FIG. 10, computer system 1000 may comprise an exemplary client or server computer system. Computer system 1000 comprises a communication mechanism or bus 1011 for communicating information, and a processor 1012 coupled with bus 1011 for processing information. Processor 1012 includes a microprocessor, but is not limited to a microprocessor, such as, for example, Pentium™, PowerPC™, Alpha™, etc.

System 1000 further comprises a random access memory (RAM), or other dynamic storage device 1004 (referred to as main memory) coupled to bus 1011 for storing information and instructions to be executed by processor 1012. Main memory 1004 also may be used for storing temporary variables or other intermediate information during execution of instructions by processor 1012.

Computer system 1000 also comprises a read only memory (ROM) and/or other static storage device 1006 coupled to bus 1011 for storing static information and instructions for processor 1012, and a data storage device 1007, such as a magnetic disk or optical disk and its corresponding disk drive. Data storage device 1007 is coupled to bus 1011 for storing information and instructions.

Computer system 1000 may further be coupled to a display device 1021, such as a cathode ray tube (CRT) or liquid crystal display (LCD), coupled to bus 1011 for displaying information to a computer user. An alphanumeric input device 1022, including alphanumeric and other keys, may also be coupled to bus 1011 for communicating information and command selections to processor 1012. An additional user input device is cursor control 1023, such as a mouse, trackball, trackpad, stylus, or cursor direction keys, coupled to bus 1011 for communicating direction information and command selections to processor 1012, and for controlling cursor movement on display 1021.

Another device that may be coupled to bus 1011 is hard copy device 1024, which may be used for marking information on a medium such as paper, film, or similar types of media. Another device that may be coupled to bus 1011 is a wired/wireless communication capability 1025 to communication to a phone or handheld palm device.

Note that any or all of the components of system 800 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method for delivery of information over a time-varying network topology, the method comprising:
for each of a plurality of time intervals,
determining a virtual network topology for use over each time interval,
selecting for the time interval, based on the virtual network topology, a fixed network code for use during the time interval, and
coding information to be transmitted over the time-varying network topology using the fixed network code with necessary virtual buffering at each node.

2. The method defined in claim 1 wherein the network topology varies due to one or more of link failures, link deletions, and link additions; time-varying capacity per link, time-varying bandwidth per link, time-varying throughput per link; time-varying inter-connectivity of network nodes; and node failures, node deletions, or node additions.

3. The method defined in claim 1 wherein the virtual network topology used for a time interval comprises one or more of a group consisting of:
a first topology with each edge capacity set to the average capacity, bandwidth, or throughput of the corresponding network interface until the current time;
a second topology with each edge capacity set to an autoregressive moving average of capacity, bandwidth, or throughput of the corresponding network interface until the current time;
a third topology with edge capacities set as the outputs of a neural network, fuzzy logic, or any learning and inference algorithm that uses the time-varying link capacities, bandwidths, or throughputs as the input;
a fourth topology defined as a minimum topology from a set of topologies defined as the average topology over some set of finite time intervals; and
a fifth topology defined as any of the first, second, third or fourth topologies having one or more of the following modifications: selected links are removed, selected nodes are removed, selected link bandwidths are changed, according to some criterion or set of criteria

4. The method defined in claim 1 wherein the time-varying network topology comprises a plurality of information sources and a plurality of information sinks as part of an arbitrary network of communication entities operating as network nodes.

5. The method defined in claim 4 wherein each network node of the topology consists of a set of one or more incoming physical interfaces to receive information into said each network node and a set of one or more outgoing physical interfaces to send information from said each network node.

6. The method defined in claim 5 further comprising performing an encoding function that maps input packets to output packets on outgoing physical interfaces at each node.

7. The method defined in claim 5 further comprising determining buffering time of input packets and mapping corresponding input packets to individual coding functions, to produce an associated number of output packets generated at each node.

8. The method defined in claim 1 wherein the fixed network code is selected to achieve long-term multicast capacity over the time-varying network.

9. The method defined in claim 1 further comprising choosing among many fixed network codes a code with better decoding delay characteristics.

10. The method defined in claim 1 where the fixed network code is selected among many fixed network codes that satisfy a delay decoding constraint, as the one that achieves the largest multicast capacity.

11. The method defined in claim 1 wherein computing the virtual graph is performed based on a prediction of an average graph to be observed for the session duration.

12. The method defined in claim 1 further handling incoming packets at a node in the network using a virtual buffer system in conjunction with the fixed network code.

13. The method defined in claim 12 using the virtual buffer system to determine scheduling for transmitting packets and to determine whether or not to discard packets.

14. The method defined in claim 13 wherein the network code dictates input and output encoding functions and buffering decisions made by the virtual buffer system for the node.

15. The method defined in claim 1 further handling incoming and outgoing packets at a node in the network using a virtual buffer system that contains one or more virtual input buffers and one or more virtual output buffers.

16. The method defined in claim 15 further comprising:
obtaining information from one or more of the physical incoming interfaces;
placing the information onto virtual input buffers;
passing information from the virtual input buffers to one or more local network coding processing function blocks to perform coding based on the network code for the time interval;
storing the information in the virtual output buffers once they become available from at the outputs of the one or more function blocks; and
sending the information from virtual output buffers into physical output interfaces.

17. The method defined in claim 16 wherein the one or more local network coding processing function blocks are based on a virtual-graph network code.

18. The method defined in claim 17 further comprising programming virtual input and output buffers in the virtual buffer system for the network code.

19. The method defined in claim 1 wherein the time-varying network topology to exist at a time interval comprises one or more of a group consisting of:
a first topology with each edge capacity set to a difference between the average capacity, bandwidth, or throughput of the corresponding network interface up to the time interval and a residual capacity that is calculated based on the sizes of virtual output buffers;
a second topology with each edge capacity set to a difference between an autoregressive moving average of capacity, bandwidth, or throughput of the corresponding network interface up to the time interval and a residual capacity that is calculated based on the sizes of virtual output buffers; and
a third topology with edge capacities set as outputs of a neural network, fuzzy logic, or a learning and inference algorithm that uses the time-varying link capacities, bandwidths, or throughputs, as well as the sizes of virtual output buffers as its input.

20. An article of manufacture having one or more computer readable media storing executable instructions thereon which, when executed by a system, cause the system to perform a method for delivery of information over a time-varying network topology, the method comprising:
for each of a plurality of time intervals,
determining a virtual network topology for use over each time interval,
selecting for the time interval, based on the virtual network topology, a fixed network code for use during the time interval, and
coding information to be transmitted over the time-varying network topology using the fixed network code with necessary virtual buffering at each node.

21. A node for use with a network having a time-varying network topology of nodes, the node comprising:
one or more physical incoming interface buffers operable to receive incoming packets from nodes in the network when coupled to the network;
one or more physical outgoing interface buffers operable to transfer outgoing packets when the node is coupled to the network; and
a network coding function coupled to the physical incoming and outgoing interface buffers via a virtual buffer system, the network coding function to code packets for each of a plurality of time intervals, using a network code selected for the time interval based on a virtual network topology, where the fixed network code for use during the time interval.

22. The node defined in claim 21 wherein the network code is selected by
computing a virtual graph; and
identifying the network code from a group of possible network codes that maximizes multicast capacity of the virtual graph when compared to the other possible network codes.

23. The node defined in claim 21 wherein the one or more physical incoming interfaces receive incoming packets that are placed into one or more virtual input buffers of the virtual buffer system, and further wherein the packets are passed to one or more local network coding processing function blocks to perform coding based on the network code for the time interval, the coded packets being stored in one or more virtual output buffers of the virtual buffer system and thereafter sent from the one or more virtual output buffers into the one or more physical output interfaces.
